(19) United States
(12) Patent Application Publication
(10) Pub. No.: US 2019/0149571 A1
(43) Pub. Date: May 16, 2019

(54) METHOD AND DEVICE FOR REPAIRING PAGE VULNERABILITY

(71) Applicant: PING AN TECHNOLOGY (SHENZHEN) CO., LTD., Shenzhen, Guangdong (CN)

(72) Inventor: Xingyu OUYANG, Shenzhen (CN)

(21) Appl. No.: 16/097,392

(22) PCT Filed: Feb. 11, 2018
(86) PCT No.: PCT/CN2018/076259

§ 371 Date: Oct. 29, 2018

(30) Foreign Application Priority Data
Feb. 16, 2017 (CN) 201710083516.0

(51) Int. Cl. H04L 29/06; H04L 29/08; H04L 12/26; G06F 16/957; G06F 16/958

(52) U.S. Cl. CPC H04L 63/1433; H04L 67/02; G06F 16/972; G06F 16/9577; H04L 43/0817

(57) ABSTRACT

The present application provides a method and a device for repairing page vulnerability, this method comprises: reading, via a mobile terminal, a local address, an on-line address and a preset identifier in a local database, wherein the repair resource corresponds to a page vulnerability in the local resource, the preset identifier is indicative of whether the mobile terminal has downloaded the repair resource, the server sends the on-line address and a first preset value of the preset identifier to the mobile terminal in advance, the mobile terminal writes the first preset value into the local database after receiving the first preset value that is sent out; and reading, via the mobile terminal, the corresponding repair resource on-line through the on-line address so as to render a page, if an assignment of the preset identifier is detected to be the first preset value.

The present application claims the priority of Chinese patent application filed on Feb. 16, 2017 with the application number of 201710083516.0 and entitled “a method and device for repairing page vulnerability”, said Chinese patent application is incorporated herein by reference in its entirety.

### TECHNICAL FIELD

The present application pertains to the technical field of communication, and particularly to a method and a device for repairing page vulnerability.

### BACKGROUND

A page application program (abbreviated as web application) developed based on Hypertext Markup Language after the fifth modification (abbreviated as HTML5 or H5) is established on the basis of a page. Some resources need to be acquired to perform page rendering before the page is displayed. If these resources need to be acquired on-line before the page is displayed each time, a response speed of the page may be decreased. Therefore, the required resources can be downloaded by the mobile terminal locally, and be taken as local resources, such that the response speed of the web application can be accelerated.

In related art, if there exists a page vulnerability (or called as page vulnerability) in the local resource, a software developer may limit the use of the web application, only after a client side downloads a patch compression package, decompresses repair resources in the patch compression package and replaces the page vulnerability with the repair resources in the patch compression package can the web application be started normally, generally speaking, the software developer would not develop a patch compression package for one single page vulnerability independently, for this reason, a patch compression package usually contains repair resources of a plurality of bugs. Thus, a user usually needs to wait for a long time for downloading of the patch compression package.

Aiming at the problem in the related art that, for repairing page vulnerability, it needs to download and decompress a patch compression package with a large storage occupation firstly, only in this way can the web application be enabled to be started, which results in a slow response when the page vulnerability is repaired, there is no satisfactory solution in the current industry.

### SUMMARY

A purpose of the present application is providing a method and device for repairing page vulnerability, which aims at solving the problem in related art that a response is slow when the page vulnerability is repaired.

The present application provides a method for repairing page vulnerability, comprising:

reading, via a mobile terminal, a local address, an on-line address and a preset identifier in a local database, wherein the local address is an address of a local resource in a page application, and the on-line address is an address of a repair resource in the server, the repair resource corresponds to a page vulnerability in the local resource, the preset identifier is indicative of whether the mobile terminal has downloaded the repair resource; the server sends the on-line address and a first preset value of the preset identifier to the mobile terminal in advance; the mobile terminal writes the first preset value into the local database after receiving the first preset value that is sent out; and

reading, via the mobile terminal, the corresponding repair resource on-line through the on-line address so as to render a page, if an assignment of the preset identifier is detected to be the first preset value.

The present application provides another method for repairing page vulnerability, comprising:

monitoring, via a server, whether a page application of a mobile terminal contains a page vulnerability through a preset channel;

acquiring a repair resource corresponding to the page vulnerability so as to repair the page vulnerability, if it is monitored that the page application contains the page vulnerability;

determining an on-line address of the repair resource by the server;

sending the on-line address of the repair resource to the mobile terminal by the server; and

monitoring, via the server, whether the mobile terminal has downloaded the repair resource through the channel; and reading, via the mobile terminal, the corresponding repair resource on-line through the on-line address so as to render a page if the mobile terminal fails to download the repair resource.

The present application implements a jump from the page vulnerability to the repair resource, since the jump time is earlier than the time when the repair resource is downloaded, so that a page access can be implemented without waiting to complete downloading and decompression of the repair resource; thus, when there is a page vulnerability and repair resources aren't stored locally, the web application can skip an access path into the on-line resource, thereby rendering the page through the on-line resource while implementing downloading of the repair resource, such that a normal use of the web application can be guaranteed.

### BRIEF DESCRIPTION OF THE DRAWINGS

FIG. 1 illustrates a schematic diagram of a system for repairing page vulnerability provided by one embodiment of the present application;

FIG. 2 illustrates a flow diagram of a method for repairing page vulnerability provided by one embodiment of the present application;

FIG. 3 illustrates a flow diagram of another method for repairing page vulnerability provided by one embodiment of the present application;

FIG. 4 illustrates a structural block diagram of a device for repairing page vulnerability provided by one embodiment of the present application; and

FIG. 5 illustrates a structural block diagram of another device for repairing page vulnerability provided by one embodiment of the present application.

### EMBODIMENTS OF THE PRESENT APPLICATION

In order to make the purpose, the technical solution and the advantages of the present application be clearer and more understandable, the present application will be further described in detail below with reference to accompanying figures and embodiments. It should be understood that the specific embodiments described herein are merely intended to illustrate but not to limit the present application.

FIG. 1 illustrates a system for fixing a page vulnerability provided by an embodiment of the present application, as shown in FIG. 1, the system comprises a server 110 and a mobile terminal 120, a method for fixing the page vulnerability is described from the perspective of the server 110 and the mobile terminal 120 respectively below.

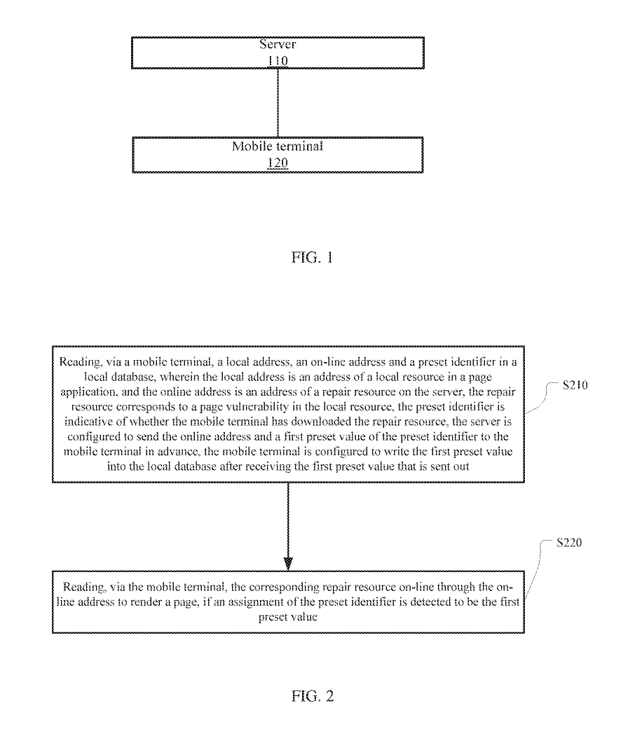

FIG. 2 is a flow diagram of the method for repairing page vulnerability according to the embodiment of the present application, an execution-subject of this method can be a mobile terminal, as shown in FIG. 2, and the method comprises step 210 and step 220.

Step 210, reading, via a mobile terminal, a local address, an on-line address and a preset identifier in the local database, wherein, the local address is an address of a local resource in the page application, the on-line address is an address of repair resource in the server, the repair resource corresponds to the page vulnerability in the local resource, the preset identifier is indicative of whether the mobile terminal has downloaded the repair resource or not; the server sends a first preset value of the on-line address and the preset identifier to the mobile terminal in advance, the mobile terminal writes the first preset value into the local database after receiving the first preset value that is sent out.

Local resources are stored in the local address of the mobile terminal, the page vulnerability exists in the local resources sometimes, at the moment, the server can provide an on-line address of the repair resource, so that the mobile terminal can download the repair resource locally so as to repair the page vulnerability, the preset identifier can indicate whether the mobile terminal has downloaded the repair resource locally.

The page vulnerability may cause an error in display or functionality of a web application, the web application needs to be checked for better user experience, the page vulnerability can be automatically detected by a server or by a web application, and can also be manually detected, a page position, a file position, etc. of the page vulnerability can be recorded after the page vulnerability is found, and the repair resource is provided in time. The web application downloads the repair resource into the mobile terminal and uses the repair resource for replacing the page vulnerability, thereby avoiding an error from occurring before the page is rendered.

Preferably, before this step, the mobile terminal can write the first preset value of the preset identifier into the local database, a channel is arranged between the server and the mobile terminal, the server monitors the mobile terminal through the channel, if the server monitors that the page application contains the page vulnerability, the on-line address of the repair source and the first preset value of the preset identifier are sent out.

A long connection is established between the server and the mobile terminal through a special channel, the server can obtain a use condition of the page application in the mobile terminal through bottom layer codes of the operation system such as bottom layer codes of Android system, the use condition can be, for example, whether there exists a page vulnerability, and whether the page vulnerability has been repaired or not.

The mobile terminal can read a preset identifier in the local database; the mobile terminal determines that the page vulnerability is not repaired if an assignment of the preset identifier is a first preset value, or determines that the page vulnerability has been repaired if the assignment of the preset identifier is a second preset value.

The preset identifier is indicative of a repair state, according to the embodiment of the present application, the first preset value can be set to be 1, and the second preset value can be set to be 0; that is, when the preset identifier is 1, it is indicated that the page vulnerability is not repaired; when the preset identifier is 0, it is indicated that the page vulnerability is repaired.

There is a corresponding relationship between repair resources and page vulnerabilitys, before the page is not repaired, when data related to the page vulnerability needs to be read, a jump to the repair resources is performed, so that an error is avoided.

In particular, the local database comprises a relative address of the local resource corresponding to the page vulnerability, the on-line address of the repair resource in the server and the preset identifier, the web application reads the database and checks whether there exists the page vulnerability in the page before each page is loaded. If there exists the page vulnerability in the page, the preset identifier of the page is further obtained, if the page vulnerability has been repaired, an access is performed directly according to the local resource address; if the page vulnerability is not repaired, the address of the repair resource in the server is obtained.

In a preferred embodiment, the local resource can be stored in a file:

file:///data/user/0/${appPackageName}/files/cache_dir/h5_js

the relative address is a resource address in the file, for example, a relative address of a page of the local resource is home/page/index.html, then, a corresponding local address stored locally can be file:///data/user/0/$/{appPackageName}/files/cache_dir/h5_js/home/page/index.html.

If there exists the page vulnerability in the relative address home/page/index.html of the web application, then, repair information may be received from the server during use.

A structure of the local database can be as follows:

| | | Modified | Explanation of | |
|---|---|---|---|---|
| Relative address | On-line address | version | Modification | Identifier |
| home/page/index.html | http://www.pingan.com/ | 1.1 | Explanation of | 1 |
| | home/page/index.html | | problem to be | |
| | | | modified | |
| home/page/index1.html | http://www.pingan.com/ | 1.1 | Explanation of | 0 |
| | home/page/index1.html | | problem to be | |
| | | | modified | |
| home/page/index2.html | http://www.pingan.com/ | 1.1 | Explanation of | 0 |
| | home/page/index2.html | | problem to be | |
| | | | modified | |

Wherein, the modified version is referred to as a version number corresponding to a modified page. The explanation of modification is an explanation of modification for the page vulnerability. If the value of the identifier is 1, it means that the page vulnerability hasn't been modified; if the value of the identifier is 0, it means that the page vulnerability has been modified.

Preferably, the mobile terminal can download the corresponding repair resource through the on-line address after acquiring the on-line address of the repair resource. After the repair resource is downloaded locally, the repair resource can be read directly and locally next time, the speed of reading the repair resource locally is generally and obviously higher than the speed of reading the repair resource from the server.

The preset identifier is sent to the mobile terminal by the server, and then is written into the local database by the mobile terminal, further, after the mobile terminal downloads the corresponding repair resource through the on-line address, the assignment of the preset identifier can be modified. In particular, the mobile terminal may write a second preset value of the preset identifier into the local database, if the server monitors that the mobile terminal has downloaded the repair resource, it sends out the second preset value of the preset identifier, after receiving the second preset value that is sent out, the mobile terminal writes the second preset value into the local database.

After downloading is completed, the assignment of the preset identifier is modified, then, when the page is loaded next time, whether the page is repaired or not can be determined according to the assignment of the preset identifier, so that local resources can be directly accessed.

For example, when the web application loads a page of home/page/index.htm, the local database can be queried firstly, if a record which needs to be repaired is stored in the database, a relative address of a path of reading data is replaced with an on-line address, and then is rendered into a corresponding interface; meanwhile, the content of the on-line address is downloaded to the local database, and the assignment of the preset identifier in the local database is modified after the downloading is completed.

S220, reading, via the mobile terminal, the corresponding repair resource on-line through an on-line address so as to render the page, if it is detected that the assignment of the preset identifier is a first preset value.

According to the on-line address of the repair resource obtained from the step 210, on-line reading can be performed for the repair resources on the server, the page can be correctly rendered according to the repair resource, thereby guaranteeing a correct display of the web application.

According to the embodiment of the present application, a jump from the page vulnerability to the repair resource is implemented, since the jump time is earlier than the time when the repair resource is downloaded, so that a page access can be implemented without waiting to complete downloading and decompression of the repair resource; thus, when there is a page vulnerability and repair resources aren't stored locally, the web application can skip an access path into the online resource, thereby rendering the page through the online resource while implementing downloading of the repair resource, such that a normal use of the web application can be guaranteed.

In particular, according to the present solution, a jump approach is implemented by determining a corresponding relationship between the page vulnerability and the repair resource, and selecting an on-line or local resource according to a preset identifier in the database, there is no need to modify characters in the original page vulnerability for the jump approach.

Compared with the prior art that repairing the page vulnerability involves a local jump from local resources to repair resources after the repair resources are downloaded, according to the embodiment of the present application, the jump between a local file and an on-line file can be realized.

Furthermore, the embodiment of the present application provides a repair resource for on-line access and a repair resource used to be downloaded locally, in this way, a repair resource does not need to be downloaded, the web application can be started without waiting for completion of downloading of the repair resource, waiting time is shortened. Meanwhile, the web application can also download the repair resource locally, such that when the web application is started next time, the local resources can be directly used to replace the mode of accessing on-line resource on the server through the network, thereby speeding up an access speed.

In conclusion, the embodiment of the present application can enable the web application to access and read the repair resource on-line while downloading the repair resource. In the prior art, one of the reasons of failing to provide the on-line resource is that all resources are accessed on-line, there is huge data amount, and thus a response speed of a web application may be influenced; in the embodiment of the present application, except for the local resources involved by the page vulnerability, other resources can be accessed directly and locally, so that the dependence on the on-line resource is weak. In the embodiment of the present application, except for the local resources involved by the page vulnerability, other resources can be accessed directly and locally due to the fact that a corresponding relationship is established between the page vulnerability and the repair resource, so that the local resources can be accessed most of time, and the jump is performed when there exists an unrepaired page vulnerability in the local resource, and thus the on-line repair resources in the server can be accessed; for this reason, not only can the page vulnerability be avoided, but also the response speed can be guaranteed to the maximum extent.

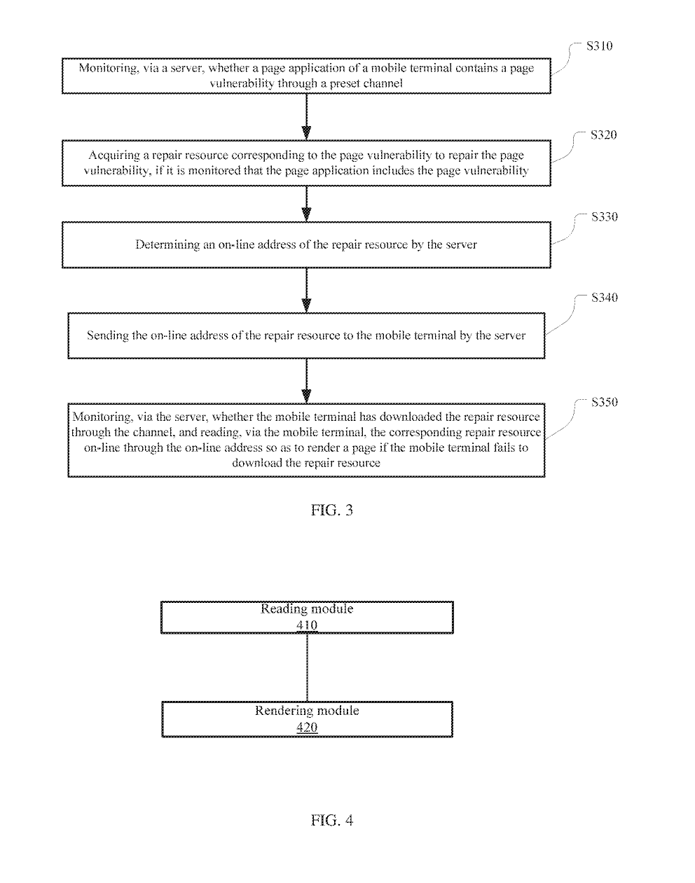

FIG. 3 is a flow diagram of another method for repairing page vulnerability according to an embodiment of the present application, the execution subject of the method can be a server, as shown in FIG. 3, the method comprises steps from step 310 to step 350.

Step 310, monitoring, via a server, whether a page application of a mobile terminal contains a page vulnerability through a preset channel.

A long connection is established between the server and the mobile terminal through a special channel, the server can acquire a use condition of the page application in the mobile terminal according to a bottom layer code of the operating system such as the bottom layer code of Android system, the use condition can be, for example, whether there exists a page vulnerability, and whether the page vulnerability has been repaired or not.

Step 320, obtaining the repair resource corresponding to the page vulnerability of the page application program to repair the page vulnerability, if it is monitored that the page application contains the page vulnerability.

The repair resource can be uploaded by a developer artificially or automatically generated by a repair system in a certain manner. After the repair resource is generated, the developer or the repair system can upload the repair resource to the server.

Preferably, whether the page vulnerability is repaired or not can be indicated through a preset identifier; in particular:

The server sends the first preset value to the mobile terminal, the mobile terminal writes the first preset value into the local database and read the repair resource on-line through an on-line address.

If it is detected that the mobile terminal has downloaded the repair resource, the local address of the repair resource is acquired, and the local address and the second preset value are sent to the mobile terminal; the mobile terminal writes the local address and the second preset value into the local database and read the repair resource through the local address.

The server can send the preset identifier to the mobile terminal, the mobile terminal writes the first preset value of the preset identifier into the local database, and modify the assignment of the preset identifier to be a second preset value after the repair resource is downloaded to the local. The server writes preset value of the preset identifier into the local database; if the mobile terminal downloads the repair resource, the assignment of the preset identifier is modified, in this way, when a page is loaded next time, whether the page vulnerability has been repaired or not can be known by checking the assignment of the preset identifier, so that whether resources in the local database or resources on the server should be read can be determined.

Step 330, determining an on-line address of the repair resource by the server.

After obtaining the repair resource, the server can read a storage location of the repair resource, that is, the on-line address.

Step 340, sending the on-line address of the repair resource to the mobile terminal via the server.

After the server sends the on-line address to the mobile terminal, the mobile terminal writes the on-line address into the local database, the mobile terminal can read the on-line address from the local database when the page application is performed next time.

Step 350, monitoring, via the server, whether the repair resource is downloaded by the mobile terminal through a channel and reading the corresponding repair resource on-line through the on-line address so as to render the page, if the mobile terminal fails to download the repair resource.

Preferably, the corresponding repair resource can be downloaded through the on-line address. After the on-line address is downloaded locally, the repair resource can be read directly and locally next time, the speed of reading the repair resource locally is generally and obviously higher than the speed of reading the repair resource from the server.

The on-line address is written into the local database according to a communication mechanism between the mobile terminal and the server, the mobile terminal can read and download the repair resource according to the on-line address, according to the embodiment of the present application, the repair resource used to be read on-line and the repair resource used to be downloaded locally can be provided at the same time, the repair resource to be read on-line can be executable files, and the repair resource to be downloaded locally can be in the form of compression package.

According to the embodiment of the present application, a jump from the page vulnerability to the repair resource is realized, since the jump time is earlier than the time when the repair resource is downloaded, so that a page access can be implemented without waiting to complete downloading and decompression of the repair resource; thus, when there is a page vulnerability and repair resources aren't stored locally, the web application can skip an access path into the online resource, thereby rendering the page through the online resource while implementing downloading of the repair resource, such that a normal use of the web application can be guaranteed.

FIG. 4 illustrates a structural block diagram of a device for repairing page vulnerability according to an embodiment of the present application, this device can be used to perform the method for repairing page vulnerability in the embodiment shown in FIG. 2, as shown in FIG. 2, this device comprises a reading module 410 and a rendering module 420.

the reading module 410 is configured to read a local address, an on-line address and a preset identifier in a local database, wherein the local address is an address of a local resource in a page application, the on-line address is an address of a repair resource in the server, the repair resource corresponds to a page vulnerability in the local resource, the preset identifier is indicative of whether the mobile terminal has downloaded the repair resource, the server sends the on-line address and a first preset value of the preset identifier to the mobile terminal in advance, the mobile terminal writes the first preset value into the local database after receiving the first preset value that is sent out.

The rendering module 420 is configured to read the corresponding repair resource on-line through the on-line address so as to render a page, if an assignment of the preset identifier is detected to be the first preset value.

Preferably, this device further comprises: a downloading module configured to download corresponding repair resource through the on-line address.

Preferably, this device further comprises: a first writing module configured to write the first preset value of the preset identifier into the local database, wherein a channel is arranged between the server and the mobile terminal, the server monitors the mobile terminal through the channel and send out the on-line address of the repair resource and the first preset value of the preset identifier when monitoring that the page application contains a page vulnerability; a second writing module configured to write a second preset value of the preset identifier into the local database, the server is configured to send out the second preset value of the preset identifier when monitoring that the mobile terminal has downloaded the repair resource; the mobile terminal writes the second preset value into the local database after receiving the second preset value that is sent out.

According to the embodiment of the present application, a jump from the page vulnerability to the repair resource is realized, since the jump time is earlier than the time when the repair resource is downloaded, so that a page access can be implemented without waiting to complete downloading and decompression of the repair resource; thus, when there is a page vulnerability and repair resources aren't stored locally, the web application can skip an access path into the online resource, thereby rendering the page through the online resource while implementing downloading of the repair resource, such that a normal use of the web application can be guaranteed.

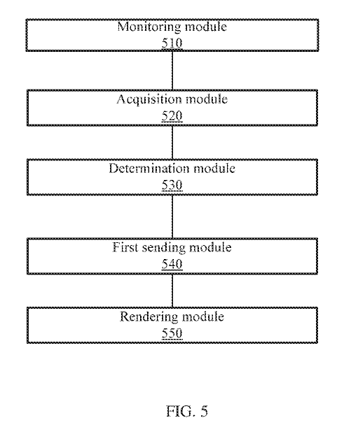

FIG. 5 illustrates a structural block diagram of another device for repairing page vulnerability provided by another embodiment of the present application, said device is used for performing the method for repairing page vulnerability in the embodiment shown in FIG. 3; as shown in FIG. 5, said device comprises a monitoring module 510, an acquisition module 520, a determination module 530, a first sending module 540 and a rendering module 550.

the monitoring module 510 is configured to monitor whether a page application of a mobile terminal contains a page vulnerability through a preset channel;

the acquisition module 520 is configured to acquire a repair resource corresponding to the page vulnerability so as to repair the page vulnerability, if it is monitored that the page application contains the page vulnerability;

the determination module 530 is configured to determine an on-line address of the repair resource;

the first sending module 540 is configured to send the on-line address of the repair resource to the mobile terminal; and

the rendering module 550 is configured to monitor whether the mobile terminal has downloaded the repair resource through the channel and read the corresponding repair resource on-line through the on-line address so as to render a page, if the mobile terminal fails to download the repair resource.

Preferably, said device further comprises: a second sending module configured to send a first preset value to the mobile terminal, wherein the mobile terminal writes the first preset value into a local database and reads the repair resource on-line through the on-line address; and

a third sending module configured to acquire a local address of the repair resource and send the local address and a second preset value to the mobile terminal if it is detected that the mobile terminal has downloaded the repair resource, the mobile terminal writes the local address and the second preset value into the local database and reads the repair resource through the local address.

According to the embodiment of the present application, a jump from the page vulnerability to the repair resource is realized, since the jump time is earlier than the time when the repair resource is downloaded, so that a page access can be implemented without waiting to complete downloading and decompression of the repair resource; thus, when there is a page vulnerability and repair resources aren't stored locally, the web application can skip an access path into the online resource, thereby rendering the page through the online resource while implementing downloading of the repair resource, such that a normal use of the web application can be guaranteed.

The aforementioned embodiments are only preferred embodiments of the present application, and should not be regarded as being limitation to the present application. Any modification, equivalent replacement, improvement, and so on, which are made within the spirit and the principle of the present application, should be included in the protection scope of the present application.

1. A method for repairing page vulnerability, comprising:
reading, via a mobile terminal, a local address, an on-line address and a preset identifier in a local database, wherein the local address is an address of a local resource in a page application, and the on-line address is an address of a repair resource in the server, the repair resource corresponds to a page vulnerability in the local resource, the preset identifier is indicative of whether the mobile terminal has downloaded the repair resource, the server is configured to send the on-line address and a first preset value of the preset identifier to the mobile terminal in advance, the mobile terminal is configured to write the first preset value into the local database after receiving the first preset value that is sent out; and
reading, via the mobile terminal, the corresponding repair resource on-line through the on-line address to render a page, if an assignment of the preset identifier is detected to be the first preset value.

2. The method according to claim 1, wherein after the assignment of the preset identifier is detected to be the first preset value, the method further comprises:
downloading the corresponding repair resource through the on-line address via the mobile terminal.

3. The method according to claim 2, wherein before the step of reading, via the mobile terminal, a local address, an on-line address and a preset identifier in a local database, the method further comprises:
writing, via the mobile terminal, the first preset value of the preset identifier in the local database, wherein a channel is arranged between the server and the mobile terminal; and
monitoring, via the server, the mobile terminal through the channel and sending out the on-line address of the repair resource and the first preset value of the preset identifier if the server monitors that the page application contains a page vulnerability;
and wherein after the mobile terminal downloads the corresponding repair resource through the on-line address, the method further comprises:
writing, via the mobile terminal, a second preset value of the preset identifier into the local database, sending out the second preset value of the preset identifier if the server monitors that the mobile terminal has downloaded the repair resource; and writing the second preset value into the local database after the mobile terminal receives the second preset value that is sent out.

4. A method for repairing page vulnerability, comprising:
monitoring, via a server, whether a page application of a mobile terminal contains a page vulnerability through a preset channel;
acquiring a repair resource corresponding to the page vulnerability so as to repair the page vulnerability, if it is monitored that the page application contains the page vulnerability;
determining an on-line address of the repair resource by the server;
sending the on-line address of the repair resource to the mobile terminal by the server; and
monitoring, via the server, whether the mobile terminal has downloaded the repair resource through the channel, and reading, via the mobile terminal, the corresponding repair resource on-line through the on-line address to render a page if the mobile terminal fails to download the repair resource.

5. The method according to claim 4, wherein after the step of acquiring the repair resource corresponding to the page vulnerability of the page application, the method further comprises:
sending a first preset value to the mobile terminal via the server, and writing, via the mobile terminal, the first preset value into a local database and reading the repair resource on-line through the on-line address; and
acquiring a local address of the repair resource and sending the local address and a second preset value to the mobile terminal if it is detected that the mobile terminal has downloaded the repair resource, and writing, via the mobile terminal, the local address and the second preset value into the local database and reading the repair resource through the local address.

6-10. (canceled)

11. A terminal device comprising a memory, a processor and a computer readable instruction stored in the memory and executable by the processor, wherein when executing the computer instruction, the processor implements following steps of:
reading a local address, an on-line address and a preset identifier in a local database, wherein the local address is an address of a local resource in a page application, and the on-line address is an address of a repair resource in the server, the repair resource corresponds to a page vulnerability in the local resource, the preset identifier is indicative of whether the mobile terminal has downloaded the repair resource, the server sends the on-line address and a first preset value of the preset identifier to the mobile terminal in advance, the mobile terminal writes the first preset value into the local database after receiving the first preset value that is sent out; and
reading, via the mobile terminal, the corresponding repair resource on-line through the on-line address so as to render a page, if an assignment of the preset identifier is detected to be the first preset value.

12. The terminal device according to claim 11, wherein after the assignment of the preset identifier is detected to be the first preset value, when executing the computer instruction, the processor further implements following step of:
downloading the corresponding repair resource through the on-line address via the mobile terminal.

13. The terminal device according to claim 12, wherein before the step of reading a local address, an on-line address and a preset identifier in a local database, when executing the computer instruction, the processor further implements following step of:
writing the first preset value of the preset identifier in the local database, wherein a channel is arranged between the server and the mobile terminal; the server monitors the mobile terminal through the channel; sending out the on-line address of the repair resource and the first preset value of the preset identifier if the server monitors that the page application contains a page vulnerability;
and wherein after the mobile terminal downloads the corresponding repair resource through the on-line address, when executing the computer instruction, the processor further implements following step of:
writing a second preset value of the preset identifier into the local database, sending out the second preset value of the preset identifier if the server monitors that the mobile terminal has downloaded the repair resource; and writing the second preset value into the local database after the mobile terminal receives the second preset value that is sent out.

14-20. (canceled)
